(19) United States
(12) Patent Application Publication
(10) Pub. No.: US 2024/0273420 A1
(43) Pub. Date: Aug. 15, 2024

(54) CLUSTER-BASED FEDERATED LEARNING BOOKING PLATFORM, BOOKING SYSTEM, AND BOOKING METHOD THEREOF

(71) Applicant: National Cheng Kung University, Tainan (TW)

(72) Inventors: Pau-Choo Chung, Tainan (TW); Wei-Jong Yang, Tainan (TW); Chao-Chun Chuang, Tainan (TW); Yen-Jung Chiu, Tainan (TW); Yu-Tai Wang, Tainan (TW)

(21) Appl. No.: 18/417,005

(22) Filed: Jan. 19, 2024

(30) Foreign Application Priority Data
Feb. 14, 2023 (TW) 112105224

(51) Int. Cl. G06Q 10/02

(52) U.S. Cl. CPC G06Q 10/02

(57) ABSTRACT

The present invention discloses a federated learning booking platform with a clustered architecture includes a second user end having a dataset and a training end including a main server and a sub-server operated under an assignment from the main server. The main server includes a service server, and the sub-server includes a backup server. The service server is configured to receive the booking information and communicate with the backup server and the first user end based on the booking information. The backup server is configured to store the dataset of the second user end. When the first user end enters the booking information, the first user end trains in synchronization with the backup host. Such that, the training success rate may be significantly improved.

### CROSS REFERENCE

This non-provisional application claims benefit of Taiwan Patent Application No. 112105224, filed on Feb. 14, 2023, the contents thereof are incorporated by reference herein.

### FIELD OF THE INVENTION

This invention relates to the federated learning field, in particular, to a cluster-based federated learning booking platform, a booking system and a booking method thereof.

### BACKGROUND OF THE INVENTION

Federated learning is a machine learning technique that differs from traditional centralized machine learning technique, where all relevant data is centralized on a single computing device for training to produce a model, the federated learning may train the machine learning models across multiple devices without the need to transfer training data. The federated learning adopts multi-node computation of the distributed system that distributes the work of model-training to multiple nodes. Distributed systems primarily deal with a large amount of data and allocate the computing power to relevant units. However, the federated learning emphasizes on the protection of the data privacy, so the training data does not need to be centralized on a single server for distribution and computation. Instead, each device may individually be used for training the model.”

Although federated learning has the advantage of high privacy, it is constrained by the computational capabilities of each device. When multiple devices are involved in training simultaneously, the computational capabilities of these devices may be different. This may result in the situations where the devices with better computational capabilities have to wait for devices with lower computational capabilities to complete their training before moving on to the next training session. Furthermore, if one of the devices fails during the training, all devices will not be able to complete the training session. As a result, the probability of training failure rate increases significantly along with the number of devices, and the willingness of other users to participate in the training will be reduced.

In view of this, unlike the traditional federated learning platform with a remote and heterogeneous model, this invention provides a federated learning booking platform that combines both remote and heterogeneous, and same-placed and heterogeneous service models. It utilizes a cluster-based architecture to achieve the same-placed and heterogeneous characteristic, which may significantly reduce the training failure rate and may allow users, who are willing to participate, to make training reservations anytime and anywhere.

### SUMMARY OF THE INVENTION

The main objective of the present invention is to provide a clustered federated learning booking platform, which serves as a platform for user ends to make reservations. At least one user ends may store the dataset on the backup server of the training end. When the training end receives booking information from other user ends, the training end and the backup server may communicate with the host of the other user ends. Such that, the schedule plan may become more flexible.

Another objective of the present invention is to provide a clustered federated learning booking system that includes a first user end, a second user end and a training end. The training end may obtain the dataset from the second user end. When the first user submits booking information, the training end controls the host of the first user end to train by using the dataset backed up by the training end. Such that, the training efficiency may be significantly increased.

Yet another objective of the present invention is to provide a clustered federated learning booking method. When the training end receives the booking information, the control information and the training models may be transmitted to the corresponding hosts of the user end and the backup host of the training end to conduct the training. Then, the training models are collected by the training end to generate and return the final training model, thus the training success rate may be improved.

In one embodiment of the present disclosure provides a federated learning booking platform with a clustered architecture for training based on booking information input by a first user end, including: a second user end having a dataset; and a training end including a main server and a sub-server operated under an assignment from the main server, wherein the main server includes a service server and the sub-server includes a backup server, the service server is configured to receive the booking information and communicate with the backup server and the first user end based on the booking information, the backup server is configured to store the dataset of the second user end.

Preferably, the training end further includes a booking interface configured to provide the first user end to transmit the booking information, enabling the service server to receive and communicate with the backup server and the first user end based on the booking information.

Preferably, the service server and encrypts and communicates with the first user end by a hypertext transfer protocol secure (HTTPS).

Preferably, the booking interface encrypts and communicates with the service server by a secure shell protocol (SSH).

Preferably, the booking interface is a booking web page provided by the service server or a web server.

In another embodiment of the present disclosure provides a federated learning booking system with a clustered architecture, including: a first user end configured to input booking information; a second user end having a dataset; and a training end, including a main server, a sub-server and a booking interface, wherein the sub-server operates under an assignment of the main server, the main server includes a service server, the sub-server includes a backup host, the service server receives and communicates with the backup host and the first user end through the booking interface based on the booking information, the backup host is configured to store the dataset of the second user end.

Preferably, the service server transmits corresponding control information and a first initial training model to the backup host and the first user end based on the booking information.

Preferably, the backup host trains by using the first initial training model and the dataset based on the control information to generate and return a first training model to the service server, the first user end trains by using the first initial training model based on the control information to generate and return a second training model to the service server, the service server receives and performs computations by using the first training model and the second training model to generate and return a third training model to the backup host and the first user end.

Preferably, when the first user end re-enters the booking information into the booking interface, the service server performs a test by using the first training model, the second training model and the third training model to generate a test result, used as a second initial training model, the service server transmits the control information and the second initial training model to the backup host and the first user end based on the booking information, the backup host trains by using the second initial training model and the dataset according to the control information to generate and return a fourth training model to the service server, the first user end trains by using the second initial training model according to the control information to generate and return a fifth training model to the service server, the service server performs computation by using the fourth training model and the fifth training model to generate and return a sixth training model to the backup host and the first user end.

Preferably, a number of the second user end is greater than or equal to a number of the first user end.

Preferably, the dataset of the second user end is stored on the training end, or the second user end uses the backup host of the training end for storing the dataset.

Preferably, when the second user end stores the dataset on the backup host at fixed or non-fixed time, the second user end transmits path data of the dataset and backup instructions to the service server.

Preferably, the dataset obtained by the backup host is either a copy of the dataset or a data shortcut of the dataset.

Preferably, the first user end stores desired training data on the training end, or the first user end uses the backup host of the training end for storing data.

Preferably, the control information is configured to execute an application, allowing the backup host and the first user end to connect to the service server via a secured mechanism.

Preferably, the service server possesses a host account of the backup host and use the host account as an authentication mechanism.

Preferably, notifications are sent to the first user end and second user end by emails when the training is completed.

Preferably, the first user end and the second user end obtain final training models from folders of hosts, servers, electronic devices used for training, or cloud storage.

Preferably, the second user end either store data on the backup host or use the backup host as a primary data storage space.

In another embodiment of the present disclosure provides a federated learning booking method with a clustered architecture, including: communicating with a backup host of a training end and a first user end by a service server based on booking information when the service server of the training end receives the booking information from the first user end, wherein the backup host is assigned to operate by the service server, and the backup host obtains a dataset from a second user end; transmitting control information and a first initial training model to the backup host and the first user end from the service server; conducting training by the backup host using the first initial training model and the dataset, generating and returning a first training model to the service server; conducting training by the first user end using the initial training model based on the control information, generating and returning a second training model to the service server; and generating a third training model by operating the first training model and the second training model in the service server, returning the third training model to the backup host and the first user end, wherein the second user end obtains the third training model from the backup host; wherein the service server performs a test by using the first training model, the second training model and the third training model to generate a test result, used as a second initial training model, when the first user end re-enters the booking information into the booking interface, the service server transmits the control information and the second initial training model to the backup host and the first user end.

The advantageous effect of the present invention lies in providing services simultaneously in both remote-heterogeneous and same-placed-heterogeneous modes, adopting the clustered architecture to achieve the same-placed and heterogeneous service. Such that, the training success rate may be significantly improved, and the schedule plan may be more flexible and efficient.

### BRIEF DESCRIPTION OF THE DRAWINGS

FIG. 1 is a schematic diagram of a booking platform in one embodiment of the present disclosure.

FIG. 2 is a schematic diagram of a booking system in one embodiment of the present disclosure.

FIG. 3 is a schematic diagram of a booking system in one embodiment of the present disclosure.

FIG. 0.4 is a flowchart of the booking method in one embodiment of the present disclosure.

FIG. 5 is a schematic diagram of an example in one embodiment of the present disclosure.

### DETAILED DESCRIPTION OF THE INVENTION

In order to make the aforementioned and/or other purposes, benefits, and features of the present disclosure clearer and more understandable, the following detailed description is provided, using preferred embodiments as examples.

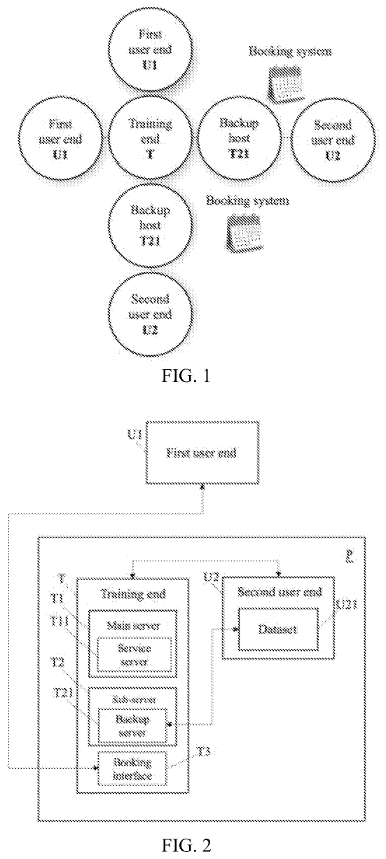

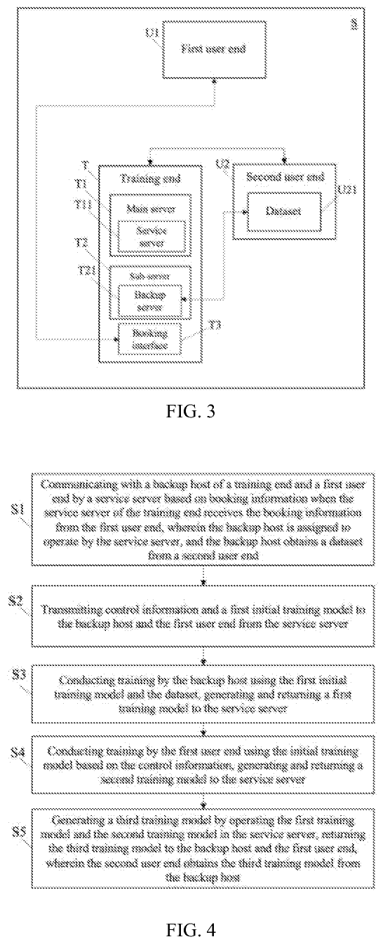

Please refer to FIG. 1 and FIG. 2, FIG. 1 is a schematic diagram of a booking platform in one embodiment of the present disclosure and FIG. 2 is a schematic diagram of a booking system in one embodiment of the present disclosure. As shown in the figures, an embodiment of the present disclosure primarily implements a same-placed and heterogeneous service model using a cluster-based architecture. In this embodiment, the second user end U2 stores the dataset U21 on the backup host T21. The booking platform may allow the user ends to make training reservations. The details are described as follows. The booking platform P in an embodiment of the present disclosure is used for the first user end U1 to input booking information for scheduling. The booking platform P may include the second user end U2 and the training end T.

In one embodiment of the present disclosure, the first user end U1 may input the booking information for scheduling the training through the host of the first user end U1, the server or any electronic devices capable of conducting training. The number of the first user end U1 is not limited, and it may be one or more. The booking information includes the reservation date and time, but it is not limited thereto.

In one embodiment of the present disclosure, the second user end U2 has a dataset U21. Preferably, the dataset U21 may be stored on any host, server, or cloud storage of the second user end U2. The number of second user end U2 is not limited, and it may be one or more. Preferably, the number of second user end U2 is greater than or equal to the number of the first user end U1, but the present disclosure is not limited thereto.

In one embodiment of the present disclosure, the training end T includes a main server T1 and a sub-server T2. The main server includes a service server T11, and the sub-server T2 includes a backup host T21. The service server T11, after receiving the booking information, communicates with the backup host T21 and the first user end U1 based on the booking information. The backup host T21 is provided for the second user end U2 to store the dataset U21. The service server T11 encrypts and communicates with the first user end U1 by a first transmission protocol. Preferably, the first transmission protocol may be hypertext transfer protocol secure (HTTPS).

Preferably, the main server T1 and the sub-server T2 are in a cluster architecture. Therefore, the sub-server T2 operates under the assignment of the main server T1, and the number of the server is not limited.

Preferably, the training end T further includes a booking interface T3. The first user end U1 may input booking information through the booking interface T3, and the service server T11 then transmit the corresponding control information and the first initial training model to the backup host T21 and the first user end U1 based on the booking information. In one embodiment of the present disclosure, the booking interface T3 may be a booking web page provided by other web servers, or it may be a booking web page provided by the service server T11.

Preferably, the booking interface T3 encrypts and communicates with the service server T11 by a second transmission protocol. Preferably, the second transmission protocol may be the secure shell protocol (SSH), but the present disclosure is not limited thereto.

In one embodiment of the present disclosure, the booking platform may be applied to industries that require machine learning and training, such as medical industry, financial industry, or other data with a critical need of privacy, but the present disclosure is not limited thereto.

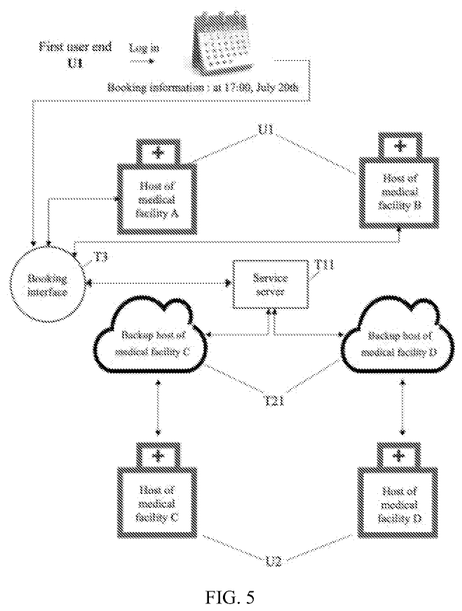

Please refer to FIG. 3, FIG. 3 is a schematic diagram of a booking system in one embodiment of the present disclosure. As shown in FIG. 3, the booking system S of an embodiment of the present disclosure includes a first user end U1, a second user end U2, and a training end T. The first user end U1 and the second user end U2 are the same with the above embodiment and will not be further described here. The operation of the system is described as follows.

Both the first user end U1 and the second user end U2 store their training data on the designated servers or cloud storage respectively. In one embodiment of the present disclosure, the first user end U1 does not store the desired training data on the training end T, while the second user end U2's dataset U21 is stored on the training end T or uses the backup host T21 of the training end T as the space for storing the dataset U21.

In another embodiment of the present disclosure, the first user end U1 may also store the desired training data on the training end T or use the backup host T21 of the training end T as the space for storing the data. That is, both the first user end U1 and the second user end U2's data may be trained under the clustered architecture of the training end T. But the present disclosure is not limited thereto.

The training end T includes a main server T1, a sub-server T2 and a booking interface T3. In one embodiment of the present disclosure, the main server T1 includes the service server T11, and the sub-server T2 includes the backup host T21. The main server T1 and the sub-server T2 are in the clustered architecture, meaning that the sub-server T2 operates under the assignment of the main server T1. But the present disclosure is not limited thereto.

Preferably, the first user end U1 may input the booking information through the booking interface T3. Such that, the service server T11, after receiving the booking information through the booking interface T3, will transmit the corresponding control information and the first initial training model to the backup host T21 and the first user end U1 based on the booking information.

In one embodiment of the present disclosure, the second user end U2 may also input the booking information through the booking interface T3, but the present disclosure is not limited thereto.

Preferably, the control information may be configured to execute an application, allowing the backup host T21 and the first user end U1 to connect to the service server T11 via a secured mechanism. In one embodiment of the present disclosure, when the service server T11 wishes to connect to the backup host T21, the service server T11 need to possess the host account of the backup host T21 and use the host account as an authentication mechanism. But the present disclosure is not limited thereto.

In one embodiment of the present disclosure, after the backup host T21 and the first user end U1 have installed the control information, the backup host T21 conducts the training using the first initial training model and the dataset U21 to generate and return the first training model to the service server T11. The first user end U1 uses the first initial training model for training to generate and return the second training model to the service server T11. The service server T11 receives and performs calculations based on the first training model and the second training model. The service server T11 generates and returns the third training model to the backup host T21 and the first user end U1.

In one embodiment of the present disclosure, after the backup host T21 and the first user end U1 receive the third training model, they may separately use the third training model for further training to generate and return the fourth training model and fifth training model to service server T11. The service server T11 receives and performs computations, based on the fourth training model and the fifth training model, to generate and return the sixth training model to backup host T21 and the first user end U1. This process continues until the training process is completed.

In one embodiment of the present disclosure, when the training is completed, notifications will be sent to the first user end U1 and second user end U2. Preferably, the notification may be sent by emails. Both the first user end U1 and the second user end U2 may individually obtain the final training model from the folder of the host, servers, electronic devices used for training, or cloud storage.

The second user end U2 may use the backup host T21 of the training end T as personal rental space. This space may be used for sharing data for learning purposes. In other words, the second user end U2 may either store data on the backup host T21 or use the backup host T21 as the primary data storage space and the using space. This approach not only eliminates privacy concerns but also makes the system not be limited by the computational capabilities of the host, server, or electronic devices of the second user end U2. Such that, the flexibility and efficiency of the federated learning may be improved.

In one embodiment of the present disclosure, after the training is completed, the service server T11 may conduct a test using all the existing training models. The test results may be used to generate the next initial model. For example, if the existing training models are the first training model and the second training model generated and returned from the backup host T21 and the first user end U1, as well as the third training model generated by the service server T11 based on the first training model and the second training model, the test will be conducted using the first training model, the second training model and the third training model. The test result may be used as the second initial training model. Similarly, if the backup host T21 and the first user end U1 have sent the fourth training model and the fifth training model to the service server T11 separately, and the service server T11 has generated the sixth training model based on the fourth training model and the fifth training model, the test may be conducted using the first training model, the second training model, the third training model, the fourth training model, the fifth training model and the sixth training model. The test result may be used as the second initial training model, which may be used as the next initial model. This allows the user ends to train by using a better model. Such that, the need for retraining may be avoided and thus improving training efficiency.

In one embodiment of the present disclosure, when the first user end U1 re-enters the booking information through the booking interface T3, the service server T11 may transmit, based on the booking information, the control information and the second initial training model, which is generated after the previous trainings, to the backup host T21 and the first user end U1. At this point, the backup host T21 conducts the training by using the second initial training model and the dataset, and the first user end U1 conducts training by using the second initial training model. The training method is as mentioned earlier, and therefore will not be described here.

In one embodiment of the present disclosure, when the second user end U2 desires to store the dataset U21 on the backup host T21 at fixed or non-fixed time, the second user end U2 may transmit the path data of the dataset and the backup instructions to the service server T11. This allows the service server T11 to control and assign the backup host T21 to obtain the dataset U21 from the second user end U2. In one embodiment, the dataset U21 obtained by the backup host T21 may be either a copy of the dataset U21 or a data shortcut of the dataset U21. In other words, the dataset U21 obtained by the backup host T21 may be actual existing data or just a path, and its data format is not limited thereto.

In another embodiment of the present disclosure, the second user end U2 may also authorize the service server T11 to assign the backup host T21 to obtain the dataset U21 from the second user end U2 at fixed or non-fixed time. This allows the service server T11 to obtain the updated dataset U21 from the second user end U2 in real-time. However, the present disclosure is not limited thereto.

In another embodiment of the present disclosure, the service server T11 may inquire, at fixed or non-fixed time, whether the second user end U2 agrees to authorize, and upon receiving backup instructions, the service server T11 to assign the backup host T21 to obtain the dataset U21 from the second user end U2, but it is not limited thereto.

In another embodiment of the present disclosure, the second user end U2 may use the backup host T21 as the storage space, thus the second user end U2 may directly store the dataset U21 on the backup host T21, but the present disclosure is not limited thereto.

Please refer to FIG. 4, FIG. 0.4 is a flowchart of a booking method in one embodiment of the present disclosure. As shown in FIG. 4, the booking method of the embodiment is executed in the aforementioned booking platform or booking system. The method includes the following steps.

In step S1, communicating with a backup host of a training end and a first user end by a service server based on booking information when the service server of the training end receives the booking information from the first user end, wherein the backup host is assigned to operate by the service server, and the backup host obtains a dataset from a second user end.

In step S2, transmitting control information and a first initial training model to the backup host and the first user end from the service server.

In step S3, conducting training by the backup host using the first initial training model and the dataset, generating and returning a first training model to the service server.

In step S4, conducting training by the first user end using the initial training model based on the control information, generating and returning a second training model to the service server.

In step S5, generating a third training model by operating the first training model and the second training model in the service server, returning the third training model to the backup host and the first user end, wherein the second user end obtains the third training model from the backup host.

As described in step S1, when the service server T11 of the training end T receives the booking information from the first user end U1, the service server T11 communicates with the backup server T21 and the first user end U1 based on the booking information. The backup server T21 is assigned to operate by the service server T11 and the backup server T21 obtains the dataset U21 from the second user end U2.

As described in step S2, the service server T11 transmits the control information and the first initial training model to the backup server T21 and the first user end U1. At this point, the backup server T21 and the first user end U1 may install the control information.

As described in step S3, then, the backup server T21 conducts the training by using the first initial training model and the dataset U21 based on the control information. The backup server T21 generates and returns the first training model to the service server T11.

As described in step S4, similarly, the first user end U1 trains by using the first initial training model based on the control information. The first user end U1 generates and returns the second training model to the service server T11. In one embodiment of the present disclosure, steps S3 and S4 may be conducted simultaneously, but the disclosure is not limited thereto.

As described in step S5, the service server T11 uses the first training model and the second training model to perform the computations to generate the third training model, which is then returned to the backup server T21 and the first user end U1. Additionally, the second user end U2 may obtain the third training model through the backup server T21. Furthermore, the service server T11 conducts the test by using the first training model, the second training model, and the third training model, and uses the test results as the second initial training model. The second initial training model may be used as the initial model for the next training. Therefore, when the service server T11 receives the booking information again from the first user end U1, the service server T11 transmits the control information and the second initial training model to the backup server T21 and the first user end U1 and the steps S3-S5 continue.

To further clarify the booking method of one embodiment of the present disclosure, please refer to FIG. 5, FIG. 5 is a schematic diagram of an example in one embodiment of the present disclosure, and the detailed description is in below.

The first user end U1 may be medical facility A and medical facility B.

The second user end U2 may be medical facility C and medical facility D.

The backup host T21 of the training end T may include the backup host of the medical facility C and the backup host of the medical facility D.

The first user end U1 logs into the booking interface T3 of the training end T with its host and enters booking information, for example, at 17:00, July 20^{th}. At this moment, the booking information is transmitted to the service server T11 by the booking interface T3. Then, the service server T11 will communicate with the host of the first user end U1 and the backup server T21 of the training end T at 17:00, July 20^{th}. The service server T11 will transmit the control information and the first initial training model to the backup server T21 and the host of the first user end U1. The backup host of the medical facility C and the medical facility D at the training end T respectively conduct the training by using the first initial training model and the obtained dataset U21 to obtain the first training model, which is then returned to the service server T11. The medical facilities A and B respectively conduct training on their host by using the first initial training model to obtain the second training model, which is returned to the service server T11.

Finally, the first training model and the second training model are processed in the service server T11 to generate the third training model, which is then returned to the host of the medical facility A, the host of the medical facility B, the backup host of the medical facility C and the backup host of the medical facility D. The host of the medical facility C may obtain the third training model through the backup host of the medical facility C, and the host of the medical facility D may obtain the third training model through the backup host of the medical facility D.

In summary, in the federated learning booking platform, the booking system, and the booking method with the clustered architecture of the present disclosure, the backup server of the training end uses the clustered architecture that allows the system to provide the services heterogeneously and within same place, and the backup host may obtain the dataset from the second user end. When the first user end inputs the booking information, the first user end and the backup host may synchronously conduct the training. Such that, the success rate of the training process may significantly be improved, and the schedule plan may become more flexible and efficient.

The above description represents only preferred embodiments of the present invention, and the scope of the present invention should not be limited to these embodiments. Therefore, any simple equivalent changes and modifications made according to the scope of the patent claims and the content of the invention disclosure are still within the scope of the present invention.

What is claimed is:

1. A federated learning booking platform with a clustered architecture for training based on booking information input by a first user end, comprising:
a second user end having a dataset; and
a training end comprising a main server and a sub-server operated under an assignment from the main server, wherein the main server comprises a service server and the sub-server comprises a backup server, the service server is configured to receive the booking information and communicate with the backup server and the first user end based on the booking information, the backup server is configured to store the dataset of the second user end.

2. The federated learning booking platform with a clustered architecture of claim 1, wherein the training end further comprises a booking interface configured to provide the first user end to transmit the booking information, enabling the service server to receive and communicate with the backup server and the first user end based on the booking information.

3. The federated learning booking platform with a clustered architecture of claim 1, wherein the service server encrypts and communicates with the first user end by a hypertext transfer protocol secure (HTTPS).

4. The federated learning booking platform with a clustered architecture of claim 2, wherein the booking interface encrypts and communicates with the service server by a secure shell protocol (SSH).

5. The federated learning booking platform with a clustered architecture of claim 2, wherein the booking interface is a booking web page provided by the service server or a web server.

6. A federated learning booking system with a clustered architecture, comprising:
a first user end configured to input booking information;
a second user end having a dataset; and
a training end, comprising a main server, a sub-server and a booking interface, wherein the sub-server operates under an assignment of the main server, the main server comprises a service server, the sub-server comprises a backup host, the service server receives and communicates with the backup host and the first user end through the booking interface based on the booking information, the backup host is configured to store the dataset of the second user end.

7. The federated learning booking system with a clustered architecture of claim 6, wherein the service server transmits corresponding control information and a first initial training model to the backup host and the first user end based on the booking information.

8. The federated learning booking system with a clustered architecture of claim 7, wherein the backup host trains by using the first initial training model and the dataset based on the control information to generate and return a first training model to the service server, the first user end trains by using the first initial training model based on the control information to generate and return a second training model to the service server, the service server receives and performs computations by using the first training model and the second training model to generate and return a third training model to the backup host and the first user end.

9. The federated learning booking system with a clustered architecture of claim 8, wherein when the first user end re-enters the booking information into the booking interface, the service server performs a test by using the first training model, the second training model and the third training model to generate a test result, used as a second initial training model, the service server transmits the control information and the second initial training model to the backup host and the first user end based on the booking information, the backup host trains by using the second initial training model and the dataset based on the control information to generate and return a fourth training model to the service server, the first user end trains by using the second initial training model based on the control information to generate and return a fifth training model to the service server, the service server performs computation by using the fourth training model and the fifth training model to generate and return a sixth training model to the backup host and the first user end.

10. The federated learning booking system with a clustered architecture of claim 6, wherein a number of the second user end is greater than or equal to a number of the first user end.

11. The federated learning booking system with a clustered architecture of claim 6, wherein the dataset of the second user end is stored on the training end, or the second user end uses the backup host of the training end for storing the dataset.

12. The federated learning booking system with a clustered architecture of claim 11, wherein when the second user end stores the dataset on the backup host at fixed or non-fixed time, the second user end transmits path data of the dataset and backup instructions to the service server.

13. The federated learning booking system with a clustered architecture of claim 12, wherein the dataset obtained by the backup host is either a copy of the dataset or a data shortcut of the dataset.

14. The federated learning booking system with a clustered architecture of claim 6, wherein the first user end stores desired training data on the training end, or the first user end uses the backup host of the training end for storing data.

15. The federated learning booking system with a clustered architecture of claim 7, wherein the control information is configured to execute an application, allowing the backup host and the first user end to connect to the service server via a secured mechanism.

16. The federated learning booking system with a clustered architecture of claim 15, wherein the service server possesses a host account of the backup host and use the host account as an authentication mechanism.

17. The federated learning booking system with a clustered architecture of claim 8, wherein notifications are sent to the first user end and second user end by emails when the training is completed.

18. The federated learning booking system with a clustered architecture of claim 9, wherein the first user end and the second user end obtain final training models from folders of hosts, servers, electronic devices used for training, or cloud storage.

19. The federated learning booking system with a clustered architecture of claim 6, wherein the second user end either store data on the backup host or use the backup host as a primary data storage space.

20. A federated learning booking method with a clustered architecture, comprising:
communicating with a backup host of a training end and a first user end by a service server based on booking information when the service server of the training end receives the booking information from the first user end, wherein the backup host is assigned to operate by the service server, and the backup host obtains a dataset from a second user end;
transmitting control information and a first initial training model to the backup host and the first user end from the service server;
conducting training by the backup host using the first initial training model and the dataset, generating and returning a first training model to the service server;
conducting training by the first user end using the initial training model based on the control information, generating and returning a second training model to the service server; and
generating a third training model by operating the first training model and the second training model in the service server, returning the third training model to the backup host and the first user end, wherein the second user end obtains the third training model from the backup host;
wherein the service server performs a test by using the first training model, the second training model and the third training model to generate a test result, used as a second initial training model, when the first user end re-enters the booking information into the booking interface, the service server transmits the control information and the second initial training model to the backup host and the first user end.
